(19) United States
(12) Patent Application Publication
(10) Pub. No.: US 2026/0358632 A1
(43) Pub. Date: Nov. 12, 2026

(54) TWO-DIMENSIONAL PUPIL EXPANSION IN A SINGLE LIGHT GUIDE STRUCTURE

(71) Applicant: GOOGLE LLC, Mountain View, CA (US)

(72) Inventors: Ozan Cakmakci, San Bruno, CA (US); Eliezer Glik, San Diego, CA (US); Oscar Alberto Martinez, San Diego, CA (US)

(21) Appl. No.: 19/125,948

(22) PCT Filed: Feb. 6, 2023
(86) PCT No.: PCT/US2023/012371

§ 371 Date: Apr. 30, 2025

Related U.S. Application Data
(60) Provisional application No. 63/422,709, filed on Nov. 4, 2022.

(51) Int. Cl. G02B 27/01

(52) U.S. Cl. CPC G02B 27/0172; G02B 2027/0123

(57) ABSTRACT

Techniques are described for providing two-dimensional eyebox and/or pupil expansion for a flat or curved reflective light guide using a single reflective structure. An incoupling structure receives display light and directs the display light into a light guide and towards an integrated reflective structure. The reflective structure redirects at least a portion of the display light to expand an eyebox of the light guide in two dimensions. The display light is directed to an outcoupler structure for directing the display light out of the light guide toward the expanded eyebox.

### BACKGROUND

The present disclosure relates generally to augmented reality (AR) eyewear, which fuses a view of the real world with a heads-up display overlay. Wearable display devices, which include wearable heads-up displays (WHUDs), eyewear display (EWD) devices, and head-mounted display (HMD) devices (all of which terms may be used interchangeably herein), are wearable electronic devices that combine real world and virtual images via one or more optical combiners, such as one or more integrated combiner lenses, to provide a virtual display that is viewable by a user when the wearable display device is worn on the head of the user. One class of optical combiner uses a light guide (also termed a waveguide) to transfer light. In general, light from a projector of the wearable display device enters the light guide of the optical combiner through an incoupler, propagates along the light guide via total internal reflection (TIR), and exits the light guide through an outcoupler. If the pupil of the eye is aligned with one or more exit pupils provided by the outcoupler, at least a portion of the light exiting through the outcoupler will enter the pupil of the eye, thereby enabling the user to see a virtual image. Since the combiner lens is transparent, the user will also be able to see the real world.

### BRIEF SUMMARY OF EMBODIMENTS

In an embodiment, a light guide comprises an incoupling structure to receive display light and to direct the display light into the light guide; a spatially integrated reflective structure to expand an eyebox provided by the light guide in two dimensions; and an outcoupling structure for directing the display light out of the light guide toward the expanded eyebox.

The two dimensions may be substantially orthogonal.

The reflective structure comprises a plurality of prisms. The plurality of prisms may comprise two intersecting sets of parallel facets. The two intersecting sets may be substantially orthogonal.

The reflective structure may comprise a plurality of substantially triangular facets.

The reflective structure may comprise an interface between a first portion of an optical substrate and a second portion of an optical substrate. The reflective structure may comprise one or more reflective coatings disposed at the interface.

The reflective structure may operate as the outcoupling structure.

The reflective structure may be spatially separated from the outcoupling structure along a path of propagation of the display light through the light guide.

### In an Embodiment, a Wearable Display Device Comprises the Light Guide.

In an embodiment, a method comprises directing display light into a light guide via an incoupler; expanding an eyebox of the light guide in two dimensions via a spatially integrated reflective structure; and directing the display light out of the light guide towards the expanded eyebox via an outcoupling structure.

Expanding the eyebox of the light guide may include expanding the eyebox in two substantially orthogonal dimensions.

Expanding the eyebox of the light guide via the reflective structure may comprise expanding the eyebox via a plurality of prisms. Expanding the eyebox via the plurality of prisms may comprise expanding the eyebox via two or more intersecting sets of parallel facets. The intersecting sets may be substantially orthogonal.

Expanding the eyebox of the light guide via the reflective structure may comprise expanding the eyebox via a plurality of substantially triangular facets.

Expanding the eyebox of the light guide via the reflective structure may comprise expanding the eyebox via an interface between a first portion of an optical substrate and a second portion of an optical substrate. The reflective structure may comprise one or more reflective coatings disposed at the interface.

The reflective structure may be substantially coincident with the outcoupling structure.

Directing the display light out of the light guide towards the expanded eyebox via the outcoupling structure may comprise directing the display light along a path of propagation between the reflective structure and the outcoupling structure within the light guide.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates a diagram of a wearable display device 100 in accordance with some embodiments.

FIG. 2 illustrates an example cross-sectional view of a one-dimensional (1D) reflective structure used for 1D eyebox expansion in a single dimension.

FIG. 3 illustrates an example cross-sectional view of another 1D reflective structure used for eyebox expansion in a single dimension.

FIG. 4 illustrates a 2D reflective structure used for two-dimensional eyebox and/or pupil expansion in accordance with some embodiments.

FIG. 5 illustrates a 2D reflective structure used for two-dimensional eyebox and/or pupil expansion in accordance with some embodiments.

FIG. 6 illustrates cross-sectional and transverse partial component views of a reflective structure used for eyebox and/or pupil expansion in accordance with some embodiments.

FIG. 7 is an operational flow diagram illustrating operations for providing 2D eyebox and/or pupil expansion in a reflective light guide using a single reflective structure, in accordance with some embodiments.

### DETAILED DESCRIPTION

Eyewear display optics intended for all-day eyewear require efficiency, image quality, thickness, manufacturability, resolution, artifacts, full color, reliability, and a curved look that is standard in the eyewear industry today. Current light guide architecture is associated with various limitations with respect to optics, aesthetics, manufacturing, thickness, and ophthalmic correction (prescription).

Wearable display devices for presenting AR content typically employ an optical combiner light guide (also referred to herein as a “light guide”) to convey and magnify display light emitted by a display to a user's eye while also permitting light from the real-world scene to pass through the light guide to the user's eye, resulting in the imagery represented by the display light overlaying the real-world scene from the perspective of the user. Typically, the light guide relies on total internal reflection (TIR) to convey light received from the display via incoupling features at one end of the light guide to outcoupling features facing the user's eye on the other end of the light guide. The outcoupling features are configured to direct light beams from within the light guide out of the light guide such that the user perceives the projected light beams as images displayed in a field of view (FOV) area of a display component located in front of a user's eye, such as a lens of an EWD device having the general shape and size of eyeglasses. The light beams exiting from the light guide then overlap at an eye relief distance from the light guide, forming a “pupil” within which a virtual image generated by the image source can be viewed.

A relatively large FOV area and pupil are desirable in an EWD device to provide an in-focus, immersive experience to the user. It is also desirable that an EWD device be able to fit a variety of users despite differences in a relative size and position of those users' respective facial features in relation to components of the EWD. For example, one design consideration for an EWD device that can be worn by a wide range of users is the “eyebox”, or a 3D volume in space within which the pupil of an eye must be positioned in order to satisfy a series of viewing experience criteria (such as the user being able to see all four edges of a virtual image). The larger the eyebox, the larger the range of users the EWD device can accommodate. Moreover, increasing the size of the eyebox of an EWD generally corresponds to an expansion of the pupil of the EWD.

A number of design elements of an EWD device contribute to the size of the FOV area, pupil, and eyebox. For example, the configuration of the outcoupling features within the outcoupling region of a light guide can be configured to provide an expanded FOV while also expanding the pupil and eyebox. Prior attempts to achieve two-dimensional (2D) eyebox and/or pupil expansion have involved utilizing two spatially separated single-dimensional (1D) reflective structures in combination.

Embodiments described herein provide 2D eyebox and/or pupil expansion for planar (flat) or non-planar (curved) reflective light guides with a single structure, such as a periodic reflective structure formed in one or more optical substrates of an optical combiner. Such a periodic reflective structure typically has a period on the order of 1 mm; for visible light wavelengths (e.g., wavelengths of approximately 350 to 700 nm), diffraction from such reflective structures will be minimal (e.g., on the order of 2 arcminutes), which are reasonably close to the Nyquist resolution of cones in the human retina. The absence of such diffraction is desirable for facets of various 2D reflective structures, described herein, that are formed between two refractive index-matched complementary portions of optical substrate, with one or more reflective coatings applied on the interface between those portions. Although the resulting reflective facets are intended to be invisible to a user, the reflective coatings may cause diffraction effects in smaller-scaled optical structures. Moreover, in certain embodiments the facets of the described reflective structures are configured such that the spacing (pitch) of such facets avoids causing diffraction artifacts, while providing reflection sufficient to expand the eyebox. Additional advantages of such embodiments include a compact footprint that allows additional industrial design options for the frame and other components of an incorporating EWD device.

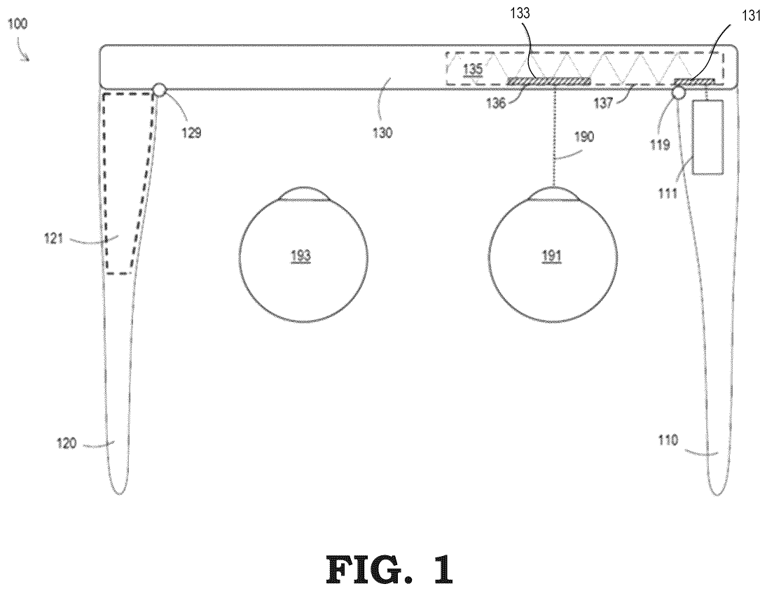

FIG. 1 illustrates a diagram of a wearable display device 100 in accordance with some embodiments. In some embodiments, the wearable display device 100 may implement or be implemented by aspects of the wearable display device 100. For example, the wearable display device 100 may include a first arm 110, a second arm 120, and a front frame 130. The first arm 110 may be coupled to the front frame 130 by a hinge 119, which allows the first arm 110 to rotate relative to the front frame 130. The second arm 120 may be coupled to the front frame 130 by the hinge 129, which allows the second arm 120 to rotate relative to the front frame 130.

In the example of FIG. 1, the wearable display device 100 may be in an unfolded configuration, in which the first arm 110 and the second arm 120 are rotated such that the wearable display device 100 can be worn on a head of a user, with the first arm 110 positioned on a first side of the head of the user, the second arm 120 positioned on a second side of the head of the user opposite the first side, and the front frame 130 positioned on a front of the head of the user. The first arm 110 and the second arm 120 can be rotated towards the front frame 130, until both the first arm 110 and the second arm 120 are approximately parallel to the front frame 130, such that the wearable display device 100 may be in a compact shape that fits conveniently in a rectangular, cylindrical, or oblong case.

Alternatively, the first arm 110 and the second arm 120 may be fixedly mounted to the front frame 130, such that the wearable display device 100 cannot be folded. In the depicted embodiment, the first arm 110 carries a light engine 111; the second arm 120 carries a power source 121.

Generally, an incoupling structure (incoupler) is used to couple the light from the projector into the light guide system and an outcoupling structure (outcoupler) is used to couple propagating light out of the light guide and send the images to the human eyes. In FIG. 1, the front frame 130 carries a light guide 135 that includes an incoupling structure (incoupler) 131, an outcoupling structure (outcoupler) 133, and at least one set of electrically conductive current paths, which provide electrical coupling between the power source 121 and electrical components (such as the light engine 111) carried by the first arm 110. In other embodiments, such electrical coupling is provided indirectly, such as through a power supply circuit, or provided directly from the power source 121 to each electrical component in the first arm 110.

The light engine 111 can output a display light 190 (simplified for this example) representative of AR content or other display content to be viewed by a user. The display light 190 can be redirected by light guide 135 towards an eye 191 of the user, such that the user can see the AR content. The display light 190 from the light engine 111 impinges on the incoupler 131 and is redirected to travel in a volume of the light guide 135, where the display light 190 is guided through the light guide, such as by total internal reflection (TIR) and/or surface treatments such as holograms or reflective coatings. Subsequently, the display light 190 traveling in the volume of the light guide 135 impinges on the outcoupler 133, which redirects the display light 190 out of the light guide 135 and towards the eye 191 of a user. In the wearable display device 100, the depicted outcoupler 133 has an eye-facing surface 136 that is parallel to (and possibly coplanar with) an eye-facing surface 137 of the light guide 135. It will be appreciated that unless clearly indicated otherwise, discussions herein apply to embodiments in which the light guide 135 may be either planar (flat) or non-planar (curved).

As used herein, the terms carry, carries or similar do not necessarily dictate that one component physically supports another component. For example, it is stated above that the first arm 110 carries the light engine 111. This could mean that the light engine 111 is mounted to or within the first arm 110, such that the first arm 110 physically supports the light engine 111. However, it could also describe a direct or indirect coupling relationship, even when the first arm 110 is not necessarily physically supporting the light engine 111.

The wearable display device 100 may include a processor (not shown) that is communicatively coupled to each of the electrical components in the wearable display device 100, including but not limited to the light engine 111. The processor can be any suitable component which can execute instructions or logic, including but not limited to a micro-controller, microprocessor, multi-core processor, integrated-circuit, ASIC, FPGA, programmable logic device, or any appropriate combination of these components. The wearable display device 100 can include a non-transitory processor-readable storage medium, which may store processor readable instructions thereon, which when executed by the processor can cause the processor to execute any number of functions, including causing the light engine 111 to output the light 190 representative of display content to be viewed by a user, receiving user input, managing user interfaces, generating display content to be presented to a user, receiving and managing data from any sensors carried by the wearable display device 100, receiving and processing external data and messages, and any other functions as appropriate for a given application. The non-transitory processor-readable storage medium can be any suitable component, which can store instructions, logic, or programs, including but not limited to non-volatile or volatile memory, read only memory (ROM), random access memory (RAM), FLASH memory, registers, magnetic hard disk, optical disk, or any combination of these components.

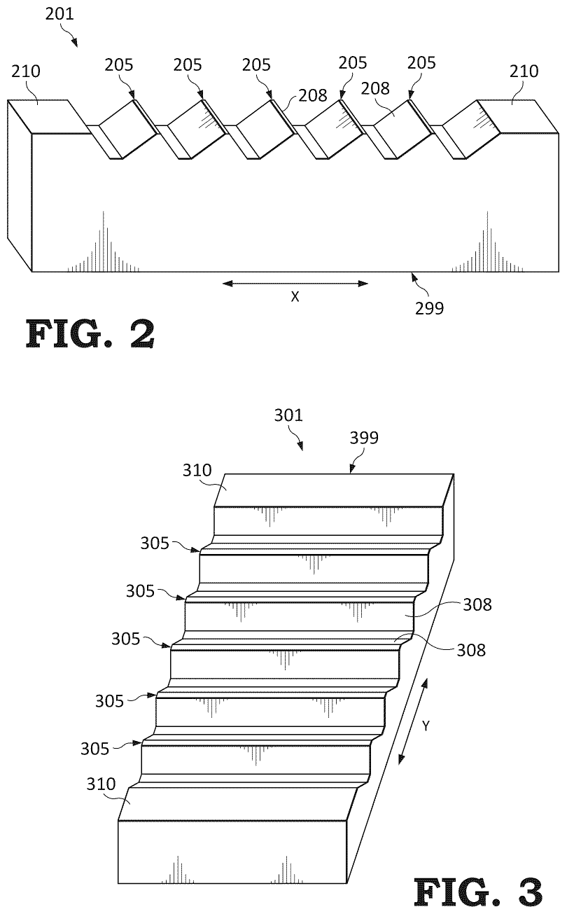

FIG. 2 illustrates an example cross-sectional view of a one-dimensional (1D) reflective structure 201 used for 1D eyebox expansion in a single dimension X. The 1D reflective structure 201 comprises a quantity of substantially triangular formations 205, formed between borders 210 in an optical substrate 299. Each of the substantially triangular formations 205 includes facets 208. A portion of any incoming light beam that interfaces with the 1D reflective structure 201 is reflected off of the substantially triangular formations 205 (and in particular off of facets 208), resulting in an expansion along dimension X of the eyebox formed at least in part by the reflected light beam.

FIG. 3 illustrates an example cross-sectional view of another 1D reflective structure 301 used for 1D eyebox expansion in a single dimension Y, which in the depicted example is substantially orthogonal to the dimension X along which the eyebox of the 1D reflective structure 201 of FIG. 2 is expanded. In a manner substantially identical to that described above with respect to the 1D reflective structure 201, the 1D reflective structure 301 comprises a quantity of substantially triangular formations 305, formed between borders 310 in an optical substrate 399. Each of the substantially triangular formations 305 includes facets 308. A portion of any incoming light beam that interfaces with the 1D reflective structure 301 is reflected off of the substantially triangular formations 305 (and in particular off of facets 308), resulting in an expansion along dimension Y of the eyebox formed at least in part by the reflected light beam.

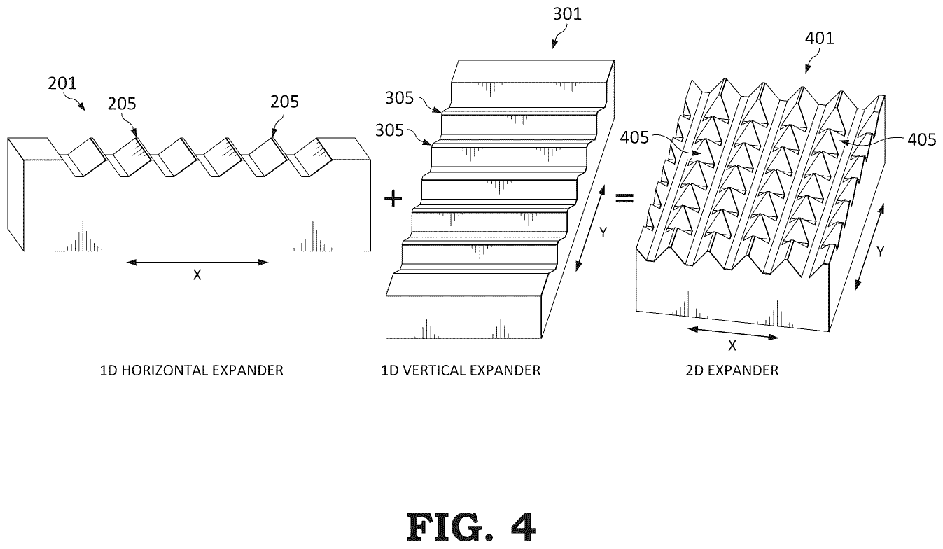

FIG. 4 illustrates a single 2D reflective structure 401 used for two-dimensional eyebox and/or pupil expansion in accordance with some embodiments. The 2D reflective structure 401 includes reflective aspects of both the 1D reflective structure 201 and the 1D reflective structure 301 in order to expand the eyebox of an incorporating light guide in two substantially orthogonal dimensions X and Y by spatially integrating those reflective aspects of the 1D reflective structures 201 and 301. As used herein, spatially integrated refers to a property of the 2D reflective structure 201 such that aspects of the 2D reflective structure 401 that expand a resulting eyebox along the X dimension overlappingly occupy a substantially identical portion of the 2D reflective structure 401 as those that expand the resulting eyebox along the Y dimension. In particular, the 2D reflective structure 401 includes a plurality of pyramidal structures 405, each having four substantially triangular facets for expanding an eyebox provided by light beams interfacing with those pyramidal structures (e.g., two facets reflecting such light beams to expand the eyebox along the X dimension and two facets reflecting such light beams to expand the eyebox along the substantially orthogonal Y dimension). In certain embodiments the reflective structure may redirect the expanded display light towards an outcoupler of the light guide; in other embodiments, the reflective structure 401 may operate as the outcoupler itself, such that the reflective structure 401 both expands the eyebox in two dimensions and outcouples the light towards that eyebox substantially simultaneously.

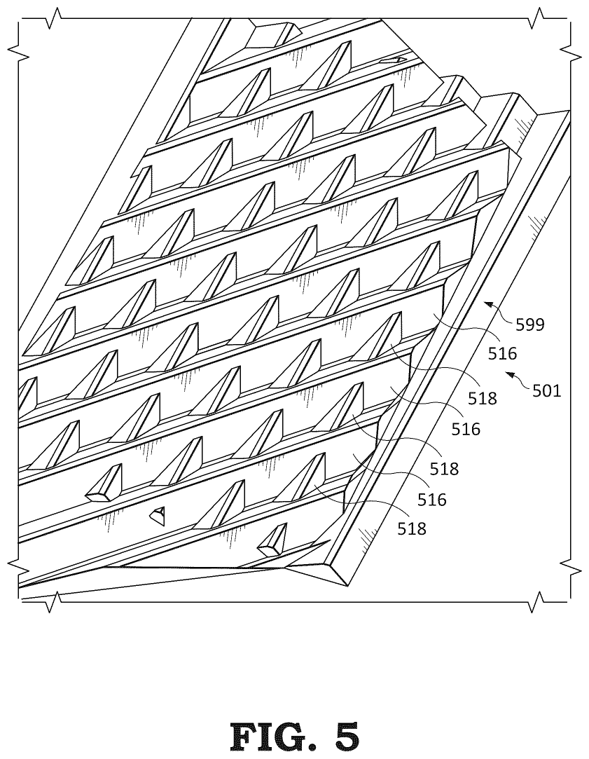

FIG. 5 illustrates a single 2D reflective structure 501 formed in an optical substrate 599. The reflective structure 501 utilizes a plurality of prisms for two-dimensional eyebox and/or pupil expansion in accordance with some embodiments. In the depicted embodiment, the plurality of prisms forms a variety of reflective facets (parallel facets 516 and substantially triangular facets 518) by which incoming display light is redirected in multiple dimensions in order to expand an eyebox provided by a light guide incorporating the reflective structure 501. However, the reflective structures 401 and 501 are configured differently, such that the intersecting prisms forming the pyramidal structures 405 of reflective structure 401 are orthogonal, while the plurality of prisms forming facets 516 and 518 of the reflective structure 501 are not. Accordingly, the reflective structure 401 expands the relevant eyebox in two substantially orthogonal dimensions, while the reflective structure 501 expands the relevant eyebox in two non-orthogonal dimensions.

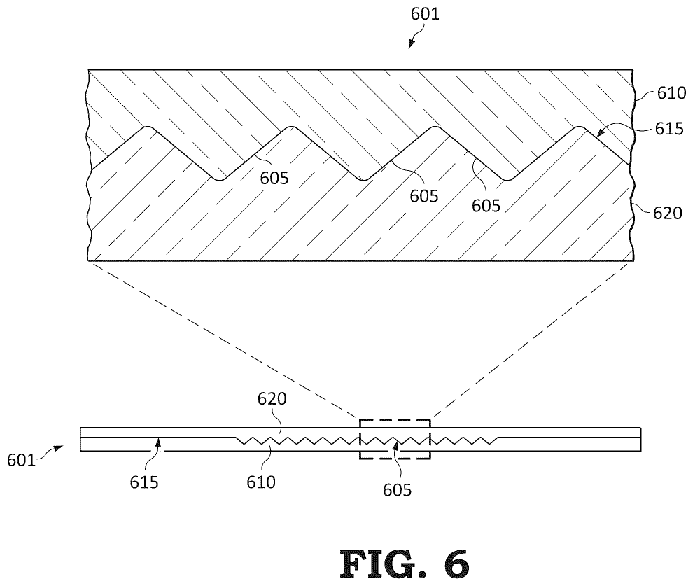

In certain embodiments, the reflective structure 501 is encapsulated as a reflective interface between separately formed complementary portions of one or more optical substrates. In such embodiments, one or more reflective coatings are applied to the interface between the complementary portions of optical substrate to form the plurality of prisms 505 as an internal reflective interface, in a manner similar to that described below with respect to FIG. 6.

FIG. 6 illustrates transverse partial component views of a single 2D reflective structure 601, which may operate substantially similarly as 2D reflective structure 401 of FIGS. 4 and/or 2D reflective structure 501 of FIG. 5. In the depicted embodiment, a first optical substrate portion 610 and a second optical substrate portion 620 are coupled at an optical interface 615. The 2D reflective structure 601 is configured to expand an eyebox of an incorporating light guide (not shown) via reflectivity provided by one or more optical coatings disposed along the optical interface 615. Because of the shape of the optical interface 615, these optical coatings operate to form internal reflective facets 605, which operate in a similar manner to that described above with respect to pyramidal structures 405 and prisms 505 of FIGS. 4 and 5, respectively. In this manner, the optical interface 615 and, more generally the 2D reflective structure 601 as a whole, provides a reflective surface that expands the provided eyebox in two distinct (and in this example, substantially orthogonal) dimensions. In certain embodiments, individual reflective facets of the 2D reflective structure 601 utilize a coating structure (e.g., a holographic Bragg mirror, an interference coating, a metallic coating, or other suitable partially reflective coating structure) that is both angularly and wavelength dependent. Such facets are generally undetectable by a user if they are associated with low reflectivity, typically 20% reflectivity or less.

In certain embodiments, internal reflective facets of the 2D reflective structure 601 are encapsulated by an incorporating light guide using the two optical substrate portions 610, 620 (such as injection molded, diamond turned, or glass molded optical substrate portions). Each of the two optical substrate portions 610, 620 comprise phase offsets, such that the opposing facets of the optical substrate portions 610, 620 form a complementary pair that are coupled together (e.g., via an index matching adhesive). Display light is injected via an incoupler facet (not shown) that is bonded inside the light guide at an angle such that the incoupler facet enables TIR of the reflected light within the optical substrate portions 610, 620. In certain embodiments, the facet is coated with a partially reflective material causing such reflection. The display light is then propagated via TIR inside the light guide due to the angle of the incoupler facet and of the incoming display light. In some embodiments, the reflective structure 601 operates as an outcoupler, such that the display light is outcoupled and expanded (in two dimensions) simultaneously. In other embodiments, a separate outcoupling structure (outcoupler, not shown) is formed in the incorporating light guide at some distance from the reflective structure 601.

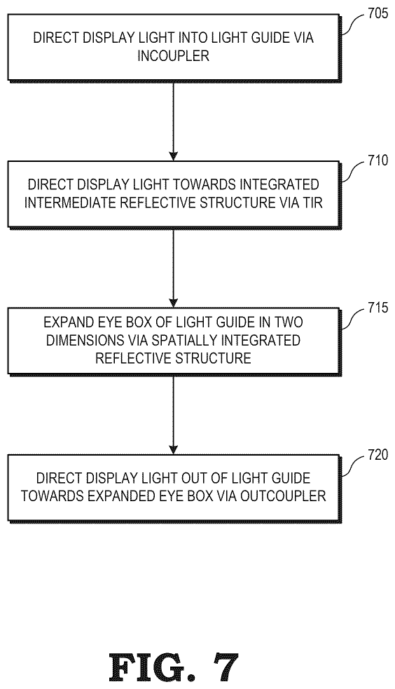

FIG. 7 is an operational flow diagram illustrating operations for providing 2D eyebox and/or pupil expansion in a reflective light guide using a single reflective structure, in accordance with some embodiments. The illustrated operations begin at block 705.

At block 705, a display light (e.g., display light 190 of FIG. 1) is directed into the reflective light guide via an incoupler (e.g., incoupler 131 of FIG. 1).

At block 710, the display light is directed towards a spatially integrated reflective structure (such as one of reflective structures 401, 501, 601, 701 of FIGS. 4-7, respectively) via TIR.

At block 715, the display light is redirected along two dimensions by the spatially integrated reflective structure, thereby expanding the eyebox provided by the light guide.

At block 720, the display light is redirected out of the light guide towards the now-expanded eyebox via an outcoupler (e.g., outcoupler 133 of FIG. 1). As noted elsewhere herein, in certain embodiments the spatially integrated reflective structure may further operate as the outcoupler of the light guide, such that the reflective structure both simultaneously expands the eyebox in two dimensions and outcouples the light towards that eyebox.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media.

The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A light guide, comprising:
an incoupling structure to receive display light and to direct the display light into the light guide; and
a spatially integrated reflective structure to expand an eyebox provided by the light guide in two dimensions.

2. The light guide of claim 1, wherein the two dimensions are substantially orthogonal.

3. The light guide of claim 1, wherein the reflective structure comprises a plurality of prisms.

4. The light guide of claim 3, wherein the plurality of prisms comprises two intersecting sets of parallel facets.

5. The light guide of claim 4, wherein the two intersecting sets are substantially orthogonal.

6. The light guide of claim 1, wherein the reflective structure comprises a plurality of substantially triangular facets.

7. The light guide of claim 1, wherein the reflective structure comprises an interface between a first portion of an optical substrate and a second portion of an optical substrate.

8. The light guide of claim 7, wherein the reflective structure comprises one or more reflective coatings disposed at the interface.

9. The light guide of claim 1, further comprising an outcoupling structure for directing the display light out of the light guide toward the expanded eyebox.

10. The light guide of claim 1, wherein the reflective structure is further to outcouple the display light out of the light guide toward the expanded eyebox.

11. A wearable display device comprising:
a light engine to output display light; and
a light guide of claim 1, comprising:
an incoupling structure to receive the display light and to direct the display light into the light guide; and
a spatially integrated reflective structure to expand an eyebox provided by the light guide in two dimensions.

12. A method, comprising:
directing display light into a light guide via an incoupler; and
expanding an eyebox of the light guide in two dimensions via a spatially integrated reflective structure of the light guide.

13. The method of claim 12, wherein expanding the eyebox of the light guide includes expanding the eyebox in two substantially orthogonal dimensions.

14. The method of claim 12, any wherein expanding the eyebox of the light guide via the reflective structure comprises expanding the eyebox via a plurality of prisms.

15. The method of claim 14 wherein expanding the eyebox via the plurality of prisms comprises expanding the eyebox via two intersecting sets of parallel facets.

16. The method of claim 15, wherein the two intersecting sets are substantially orthogonal.

17. The method of claim 12, wherein expanding the eyebox of the light guide via the reflective structure comprises expanding the eyebox via a plurality of substantially triangular facets.

18. The method of claim 12, wherein expanding the eyebox of the light guide via the reflective structure comprises expanding the eyebox via an interface between a first portion of an optical substrate and a second portion of an optical substrate.

19. The method of claim 18, wherein the reflective structure comprises one or more reflective coatings disposed at the interface.

20. The method of claim 12, further comprising directing the display light out of the light guide towards the expanded eyebox via an outcoupling structure.

21. The method of claim 12, wherein directing the display light out of the light guide towards the expanded eyebox includes directing the display light out of the light guide towards the expanded eyebox with the reflective structure.
